(19) United States
(12) Patent Application Publication
(10) Pub. No.: US 2002/0075378 A1
(43) Pub. Date: Jun. 20, 2002

(54) Multimode multi-track optical recording system

(76) Inventor: Daniel Gelbart, Vancouver (CA)

Correspondence Address: Daniel Gelbart, Creo Products Inc., 3700 Gilmore Way, Burnaby, BC, V5G 4M1, CA

(21) Appl. No.: 09/735,472

(22) Filed: Dec. 14, 2000

(51) Int. Cl. B41J 15/14

(52) U.S. Cl. 347/241

(57) ABSTRACT

A method and apparatus for an improved multimode multi-track optical recording system are disclosed. A monolithic array of individually addressable multimode laser diode stripes is imaged onto a recording media, where the individual diode spots form a plurality of tracks.

Introduction of astigmatism between the multimode laser diode and the recording medium causes the images of the diode stripes to be relatively sharply focussed on their short axes, but less focussed on their elongated axes. This blurring of the laser diode stripes' elongated axes at the surface of the recording media overcomes near-field non-uniformity in the power distribution of the multimode diode, increasing the reliability and overall performance of the recording system.

### FIELD OF THE INVENTION

The invention relates to multimode multi-track optical reading and recording using multimode laser diodes.

### BACKGROUND OF THE INVENTION

Laser diodes are available as single mode or multimode diodes. Single mode laser diodes are effectively modeled as point sources and are diffraction limited in their divergence on all axes. In contrast, multimode diodes typically have laser junctions in the form of short stripes and are often referred to as “stripe” type laser diodes. Multimode laser diodes are diffraction limited in the direction perpendicular to the junction (their short axis), but have non-diffraction limited divergence in the direction parallel to the laser junction (their elongated axis).

The emitting aperture of a multimode diode can be a single or continuous stripe, a collection of short stripes or even a collection of single mode emitters electrically connected in parallel. In this application, the phrases “multimode diode” and “multimode laser diode” should be understood to incorporate each of these different diode constructions. In addition, laser diodes can emit radiation of various different frequencies and any reference to “light” in this application should be understood to incorporate any radiation frequency.

For recording applications, the principal advantage of using multimode laser diodes is that the radiation emitted from multimode diodes can be of substantially higher power than that emitted from single mode diodes. Obviously, higher power is a desirable quality for a recording operation, where heat or optical power alter the physical characteristics of the recording media. Despite this advantageous characteristic, multimode laser diodes are often problematic to use for image recording, because of difficulty associated with their non-uniform near-field power distribution. Not only is the near-field power distribution of a multimode diode non-uniform, but it typically changes with the age and usage of the diode. In an optical recording device, this non-uniformity of the near-field power distribution leads to an unacceptable phenomenon on the recording media known as “banding”, where the recorded image may be significantly degraded. Because the non-uniform power distribution of multimode diodes may lead to data loss or corruption, most optical recording devices employ single mode laser diodes, despite their relatively low power.

Accordingly, an apparatus and method are required to improve the performance of multimode laser optical recording devices. Such an improvement would overcome non-uniformity in the near-field power distribution of the multimode laser diode and faithfully record images on a recording media without banding, data loss or data corruption.

Various attempts have been made in the prior art to address the non-uniformity of the near-field power distribution of multimode laser diodes. One solution to this problem is to combine several diode emitters onto a single focal area. In this manner, the overlapping or combining radiation from several diodes can be used to effectively “average out” the non-uniformities of any single diode. This “emitter combination” technique is exemplified by U.S. Pat. Nos. 5,517,359, 5,923,475, and 6,064,528, all of which employ several laser diodes to illuminate the entrance pupil of a light valve (also known as a “spatial light modulator”). U.S. Pat. No. 5,793,783 employs a similar emitter combination technique, using several diodes to directly illuminate a single spot on a recording surface.

The principal drawback with the emitter combination technique is that the it is inefficient in terms of both energy and space. The energy inefficiency results from the overlap of radiation from several diodes onto a single focal area. Today's commercially available multimode laser diodes produce sufficient power to individually image many types of media (i.e. without combining radiation from several diodes). While, the redundancy of the emitter combination technique does achieve a more uniform power distribution, it is inefficient, because an individual diode can supply sufficient energy to image the recording media, and any excess energy contributed by the overlapping radiation of several diodes is wasted.

A second technique demonstrated by the prior art to overcome the non-uniformity of the near-field distribution of multimode laser diodes is to simply image the diode's far-field power distribution rather than its near-field power distribution. This technique is exemplified in U.S. Pat. Nos. 5,745,153 and 5,995,475.

A drawback with imaging the far-field distribution of a multimode laser diode is that it requires a relatively large amount of space. For use in high resolution imaging applications, a relatively large far field pattern must be reduced to a small spot at the recording surface. To image the far-field power distribution of a laser diode and have a large amount of optical reduction requires a relatively long optical path length.

An additional drawback of imaging the far-field distribution is that it adds optical aberrations in both the short and elongated axes of the laser diode image. As mentioned above, the shape of the multimode laser diode junction causes the divergence of the diode radiation to be diffraction limited on the short axis, therefore it should be used without any further modifications. Any additional aberrations in the short axis are undesirable, because of lowered brightness and resolution on the recording media.

### SUMMARY OF THE INVENTION

It is an object of the present invention to provide an improved multimode multi-track optical recording system, which does not reveal the non-uniformity of the near-field power distribution of the multimode laser diode and faithfully records images onto a recording medium without banding, data loss or data corruption.

It is another object of the present invention to provide an optical recording system that overcomes the non-uniformity of the near-field power distribution of multimode laser diodes, without requiring emitter combination, which is inefficient in terms of both energy and space.

It is another object of the present invention to provide an optical recording system that overcomes the non-uniformity of the near field power distribution of multimode laser diodes, without having to directly image the far-field distribution, which requires a relatively long optical path-length and introduces unnecessary blurriness on the short axis of the diode stripe image.

It is another object of the present invention to provide an optical recording system that maximizes the power delivered to each track on the recording media, so as to be suitable for relatively high power recording applications.

In accordance with the present invention, a monolithic array of individually addressable multimode laser diodes is employed to image the surface of a radiation sensitive material. The diodes each have a short axis and a long axis. Input information is received by each of the diodes and is incorporated into a radiation pattern emitted by that diode.

The radiation patterns of each diode are directed toward the radiation sensitive surface by an anamorphic optical subsystem. An anamorphic optical system has different magnification properties on its different axes. For example, a cylindrical lens has no magnification in the direction parallel to the axis of the cylinder. The anamorphic optical subsystem introduces an astigmatism into the radiation patterns of each of the diodes. At the surface of the radiation sensitive material, the astigmatism introduced by the anamorphic optical subsystem causes the radiation patterns to be more focused on their short axis than on their elongated axis. In this manner, the information contained in the radiation patterns can be recorded onto the radiation sensitive material without revealing their near field non-uniformities.

Advantageously, the short axis of the radiation patterns of the diodes may be substantially focused.

Preferably, the radiation patterns of the diodes may be blurred on their elongated axes, such that, at the surface of the radiation sensitive material, their power distribution in the elongated axis is substantially uniform.

Preferably, the elongated axis of each radiation pattern at the radiation sensitive material may be between 1 and 5 times the size that it would have been had it been focused at the surface of the radiation sensitive material.

Advantageously, the optical subsystem may employ at least one cylindrical lens.

Advantageously, the optical recording system may be used to simultaneously record a plurality of data tracks on the surface of the radiation sensitive material.

Another aspect of the present invention involves a method of optically recording information onto the surface of a radiation sensitive material using a monolithic array of individually addressable multimode laser diodes mounted on a substrate. Each of the diodes has a short axis and an elongated axis.

The first step of the invention involves incorporating input information into the radiation patterns emitted by each of the diodes and optically directing those radiation patterns toward the radiation sensitive material. The next step involves introducing an astigmatism into the radiation patterns prior to their reaching the surface of the radiation sensitive material, such that, at the surface of the radiation sensitive material, the radiation patterns are more focused on their short axes than on their elongated axes. In this manner, the information contained in the radiation patterns can be recorded onto the radiation sensitive material without revealing their near field non-uniformities.

Advantageously, the short axis of the radiation patterns of the diodes may be substantially focused.

Another aspect of the present invention involves a method of optically recording information onto the surface of a radiation sensitive material using a monolithic array of individually addressable multimode laser diodes mounted on a substrate. Each of the diodes has a short axis and an elongated axis.

The first step of the invention involves incorporating input information into the radiation patterns emitted by each of the diodes and optically directing those radiation patterns toward the radiation sensitive material. The next step involves focusing the short axes of the radiation patterns on the surface of the radiation sensitive material, while simultaneously blurring the elongated axes of the radiation patterns at the surface of the radiation sensitive material. In this manner, the information contained in the radiation patterns can be recorded onto the radiation sensitive material without revealing their near field non-uniformities.

These and other objects of the present invention will be better understood from the following more detailed description along with the drawings and the accompanying claims.

### BRIEF DESCRIPTION OF THE DRAWINGS

FIG. 1 depicts a preferred embodiment of the invention employed in a multimode multi-track optical recording system.

FIG. 2-A depicts a typical non-uniform near-field power distribution profile of the elongated axis of a multimode diode.

FIG. 2-B depicts a substantially more uniform power distribution profile of the elongated axis of a multimode diode in accordance with the present invention.

### DESCRIPTION OF THE PREFERRED EMBODIMENT

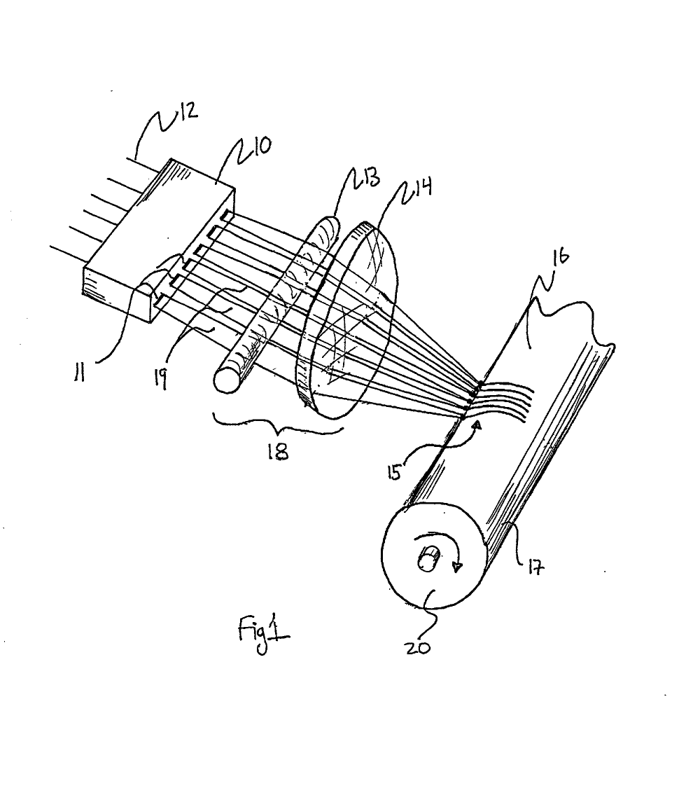

Referring to FIG. 1, a preferred embodiment of the present invention is depicted. A monolithic array 10 of individually addressable multimode laser diodes 11 receives data input (not shown) through data lines 12 and directs a corresponding set of modulated light beams 19 toward optical system 18. The radiation patterns 19 produced by the multimode laser diodes are frequently referred to as “stripes”, because of their rectangular shapes, which coincide with the shape of the diode emitting apertures. The rectangular shaped light stripes 19 have an elongated axis (the one parallel to the diode junction) and a short axis (perpendicular to the diode junction). The elongated axis is often referred to as the “slow axis”, because light diverges relatively slowly on the elongated axis. Not surprisingly, the short axis is often referred to as the “fast axis”.

Optical system 18 receives the data carrying light beams 19 and images them onto the recording medium 17. The images of each diode stripe 11 are individually focussed into a particular channel 15 on the recording medium 17. The recording medium 17 is mounted on a drum 20, which is rotated about its axis, providing a relative motion between the recording medium 17 and the optical system 18. As the drum 20 rotates, the image data is recorded onto the recording medium 17 creating a plurality of tracks 15. Relative motion between the drum 20 and the optical system 18 along the longitudinal axis of the drum 20 creates a new set of channels 15. This procedure is repeated until the desired image (not shown) is imparted onto the recording medium 17. Although the system depicted in FIG. 1 and described herein describes a particular type of imaging application, the novelty of the invention may be applied to many different optical recording systems and the invention should not be limited to recording images on the surface of a drum.

Optical system 18 is an anamorphic optical system, which may consist generally of any number of lenses or other optical elements. Anamorphic optical systems have different focal properties for different axes. The anamorphic optical system 18 introduces an astigmatism into the light beams 19. This astigmatism manifests itself when the data carrying light beams 19 are imaged into the individual channels 15 on the recording media 17. In this application, the images of the diodes 11 at the surface of the recording medium 17 are referred to as the “diode stripe images”. An alternative design places microlenses (not shown) in front of stripes 11 in order to reduce the divergence of the laser beams 19. Such microlenses can be cylindrical thus forming part of the anamorphic system, spherical, or aspheric, not introducing astigmatism. In the latter case all astigmatism is introduced by element 13 (plus the natural small astigmatism of the laser diode source).

An example of an anamorphic optical subsystem is the combination of a spherical lens 14 and a cylindrical lens 13 shown in FIG. 1. In general, there are many implementations of anamorphic optical systems and the invention should be considered to incorporate any anamorphic optical system providing the optical characteristics explained below.

The short axes of the images of the diodes 11 are focussed sharply onto recording medium 17. However, because of the astigmatism introduced by the anamorphic optical subsystem 18, the elongated axes of the images of the diodes 11 (i.e. the “slow axes”) are not focused sharply. Consequently, on the surface of the recording medium 17, the elongated axes of the diode stripe images are slightly blurred. The effect of the blurring results in an altered light intensity distribution along the elongated axes of the diode stripe images. The blurring effect is similar to the overlapping of adjacent point sources.

In general, the present invention should be understood to include the introduction of any aberration into an optical recording system, such that light from an array of multimode laser diodes is focussed relatively sharply along the short axes of the diode stripe images and is blurred along the elongated axes of the diode stripe images. Such an aberration could be astigmatism but could also be a “double image” formed by micro-prisms or diffraction, formed by grating, or any one of the well known optical methods which can cause a “smear” in the image.

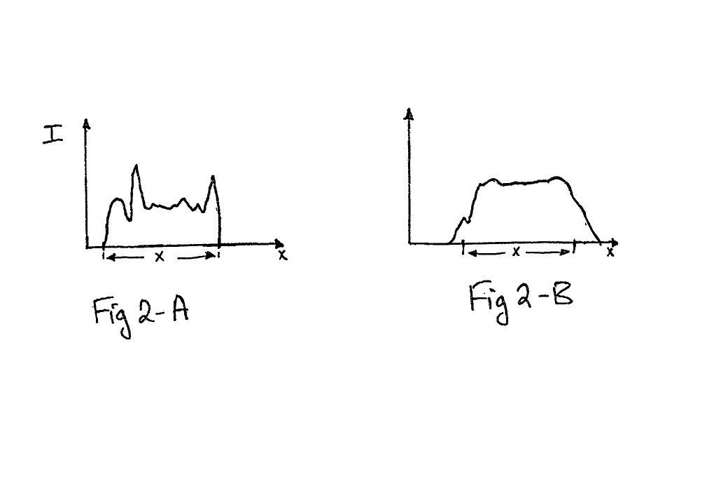

The typical non-uniform near-field intensity distribution of a diode stripe is depicted in FIG. 2-A. FIG. 2-B depicts a corresponding intensity distribution of a typical diode stripe image at the surface of the recording medium 17 after an astigmatism is introduced by anamorphic optical system 18. The plot in FIG. 2-B demonstrates how the astigmatism introduced by the anamorphic optical system 18 blurs the elongated axis and substantially reduces the non-uniformity of the power distribution in the diode stripe image. There is some undesirable blurring caused to the edges of the pixel, which limits the amount of the desirable “smear” to be from 1× to 5× the original length (unblurred length) of the pixel.

Using the apparatus and method depicted in FIG. 1, the light received at the surface of recording medium 17 is relatively uniform (i.e. the near-field power distribution of the multimode laser diodes 11 is not revealed). For this reason, an improved multimode multi-track optical recording system can be implemented, which takes advantage of high power multimode diodes, without suffering from banding, data loss or data corruption on the recording media. In addition, the system of FIG. 1, does not involve the drawbacks of reduced spatial or energy efficiency present in some of the prior art emitter combination techniques, nor does it have the long optical path length or short axis blurriness associated with imaging the far-field distribution. Finally the system of FIG. 1 is suitable for high power recording applications, because it employs a distinct laser diode for each recording track, thereby maximizing the amount of optical power available in each track on the recording surface.

It should be understood that the above description is intended for illustrative purposes only, and is not intended to limit the scope of the present invention in any way. Those skilled in the art will appreciate that various modifications can be made to the embodiments discussed above without departing from the spirit of the present invention.

What is claimed is:

1. An optical recording system for recording information on a surface of a radiation sensitive material comprising:
(a) a monolithic diode array having a plurality of individually addressable multimode laser diodes mounted on a substrate, each of said diodes having a short axis and an elongated axis and each of said diodes operative to receive input information and to emit a radiation pattern according to said input information; and
(b) an optical subsystem having at least one optical element, operative to direct each of said radiation patterns from said diodes to the surface of said radiation sensitive material,
wherein said optical subsystem introduces astigmatic blurring into said radiation patterns, such that, at the surface of said radiation sensitive material, each of said radiation patterns is substantially focused on its short axis and is blurred on its elongated axis, so as to record said information on the surface of said radiation sensitive material, while substantially avoiding revealing a near-field non-uniformity of said radiation patterns.

2. An optical system as in claim 1, wherein said astigmatic blurring is created by an astigmatic optical system.

3. An apparatus according to claim 1, wherein said optical subsystem is further operative to blur each of said radiation patterns on its elongated axis, such that, at the surface said radiation sensitive material, a power distribution of each of said radiation patterns is substantially uniform over its elongated axis.

4. An apparatus according to claim 1, wherein said optical subsystem is further operative to direct each of said radiation patterns to the surface of said radiation sensitive material in such a manner that, at the surface of said radiation sensitive material, each of said radiation patterns is between 1 and 5 times larger on its elongated axis than it would have been had it been focused on its elongated axis.

5. An apparatus according to claim 1, wherein said optical subsystem comprises at least one cylindrical lens.

6. An apparatus according to claim 1, wherein said optical recording system is further operative to simultaneously record said information in a plurality of data tracks on the surface of said radiation sensitive material.

7. An optical recording system for recording information on a surface of a radiation sensitive material comprising:
(a) a monolithic diode array having a plurality of individually addressable multimode laser diodes mounted on a substrate, each of said diodes having a short axis and an elongated axis and each of said diodes operative to receive input information and to emit a radiation pattern incorporating said input information; and
(b) an optical subsystem having at least one optical element, operative to direct each of said radiation patterns from said diodes to the surface of said radiation sensitive material,
wherein said optical subsystem is anamorphic and introduces an astigmatism into said radiation patterns, such that at the surface of said radiation sensitive material, each of said radiation patterns is more focused on its short axis than on its elongated axis, so as to record said information on the surface of said radiation sensitive material, while substantially avoiding revealing a near-field non-uniformity of said radiation patterns.

8. An apparatus according to claim 7, wherein said optical subsystem is further operative to substantially focus each of said radiation patterns on its short axis at the surface of said radiation sensitive material.

9. An apparatus according to claim 7, wherein, said optical subsystem is further operative to blur each of said radiation patterns on its elongated axis, such that, at the surface said radiation sensitive material, a power distribution of each of said radiation patterns is substantially uniform over its elongated axis.

10. An apparatus according to claim 7, wherein said optical subsystem is further operative to direct each of said radiation patterns to the surface of said radiation sensitive material in such a manner that, at the surface of said radiation sensitive material, each of said radiation patterns is between 1 and 5 times larger on its elongated axis than it would have been had it been focused on its elongated axis.

11. An apparatus according to claim 7, wherein said optical subsystem comprises at least one cylindrical lens.

12. An apparatus according to claim 7, wherein said optical recording system is further operative to simultaneously record said information in a plurality of data tracks on the surface of said radiation sensitive material.

13. A method of optically recording information onto a surface of a radiation sensitive material using a monolithic array of individually addressable multimode laser diodes mounted on a substrate, each of said diodes having a short axis and an elongated axis, which method comprises the steps of:
(a) incorporating input information into a radiation pattern emitted by each of said diodes;
(b) optically directing each of said radiation patterns from said diodes to the surface of said radiation sensitive material;
(c) introducing astigmatic blurring into said radiation patterns prior to said radiation sensitive material, such that, at the surface of said radiation sensitive material, each of said radiation patterns is substantially focused on its short axis and less focused on its elongated axis; and
(d) recording said information on the surface of said radiation sensitive material, while substantially avoiding revealing a near-field non-uniformity of said radiation patterns.

14. A method according to claim 13, wherein, at the surface of said radiation sensitive material, said directing step and said introducing step cause each of said radiation patterns from said diodes to be between 1 and 5 times larger on its elongated axis than it would have been had it been focused on its elongated axis.

15. A method according to claim 13, wherein said introducing step is accomplished using an anamorphic optical subsystem having at least one cylindrical lens.

16. A method of optically recording information onto a surface of a radiation sensitive material using a monolithic array of individually addressable multimode laser diodes mounted on a substrate, each of said diodes having a short axis and an elongated axis, which method comprises the steps of:
(a) incorporating input information into a radiation pattern emitted by each of said diodes;
(b) optically directing each of said radiation patterns from said diodes to the surface of said radiation sensitive material;
(c) introducing astigmatism into said radiation patterns prior to said radiation sensitive material, such that, at the surface of said radiation sensitive material, each of said radiation patterns is more focused on its short axis than on its elongated axis; and
(d) recording said information on the surface of said radiation sensitive material, while substantially avoiding revealing a near-field non-uniformity of said radiation patterns.

17. A method according to claim 16, wherein said directing and introducing steps cause each of said radiation patterns to be substantially focused on its short axis at the surface of said radiation sensitive material.

18. A method according to claim 16, wherein, at the surface of said radiation sensitive material, said directing step and said introducing step cause each of said radiation patterns from said diodes to be between 1 and 5 times larger on its elongated axis than it would have been had it been focused on its elongated axis.

19. A method according to claim 16, wherein said introducing step is accomplished using an anamorphic optical subsystem having at least one cylindrical lens.

20. A method of optically recording information onto a surface of a radiation sensitive material using a monolithic array of individually addressable multimode laser diodes mounted on a substrate, each of said diodes having a short axis and an elongated axis, which method comprises the steps of:
(a) incorporating input information into a radiation pattern emitted by each of said diodes;
(b) optically directing each of said radiation patterns from said diodes to the surface of said radiation sensitive material;
(c) focusing each of said radiation patterns on its short axis at the surface of said radiation sensitive material; and
(d) blurring each of said radiation patterns on its elongated axis at the surface of said radiation sensitive material, so as to record said information on the surface of said radiation sensitive material, while substantially avoiding revealing a near-field non-uniformity of said radiation patterns.
